(19) United States
(12) Patent Application Publication
(10) Pub. No.: US 2024/0012084 A1
(43) Pub. Date: Jan. 11, 2024

(54) HIERARCHICAL UE POSITIONING

(71) Applicant: QUALCOMM Incorporated, San Diego, CA (US)

(72) Inventors: Jing LEI, San Diego, CA (US); Weimin DUAN, San Diego, CA (US); Alexandros MANOLAKOS, Escondido, CA (US); Yongjun KWAK, San Diego, CA (US); Yuchul KIM, San Diego, CA (US); Huilin XU, Temecula, CA (US); Hwan Joon KWON, San Diego, CA (US)

(21) Appl. No.: 18/043,175

(22) PCT Filed: Oct. 12, 2021
(86) PCT No.: PCT/US2021/054479

§ 371 Date: Feb. 27, 2023

(30) Foreign Application Priority Data
Oct. 14, 2020 (GR) 20200100621

(51) Int. Cl. G01S 5/00; H04B 7/06; H04L 5/00; H04W 64/00; G01S 5/02

(52) U.S. Cl. CPC G01S 5/0036; H04B 7/0695; H04L 5/0048; H04W 64/00; G01S 5/0205

(57) ABSTRACT

A method for facilitating position information determination includes: sending, from a UE, an uplink reference signal to one or more base stations and a request for positioning resources to a network entity; receiving, at the UE from one or more of the one or more base stations, a plurality of first downlink reference signals in a first plurality of beams in response to the uplink reference signal and the request; determining, at the UE, a second plurality of beams, from the first plurality of beams, based on one or more respective measurements of the plurality of first downlink reference signals; and sending, from the UE to the network entity, a beam report indicating the second plurality of beams.

### CROSS-REFERENCE TO RELATED APPLICATIONS

This application claims the benefit of Greek Patent Application No. 20200100621, filed Oct. 14, 2020, entitled “HIERARCHICAL UE POSITIONING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example user equipment includes: a transceiver; a memory; and one or more processors communicatively coupled to the transceiver and the memory and configured to: send, via the transceiver, an uplink reference signal to one or more base stations and a request for positioning resources to a network entity; receive, via the transceiver from one or more of the one or more base stations, a plurality of first downlink reference signals in a first plurality of beams; determine a second plurality of beams, from the first plurality of beams, based on one or more respective measurements of the plurality of first downlink reference signals; and send a beam report to the network entity indicating the second plurality of beams.

Another example user equipment includes: means for sending an uplink reference signal to one or more base stations and a request for positioning resources to a network entity; means for receiving, from one or more of the one or more base stations, a plurality of first downlink reference signals in a first plurality of beams; means for determining a second plurality of beams, from the first plurality of beams, based on one or more respective measurements of the plurality of first downlink reference signals; and means for sending a beam report to the network entity indicating the second plurality of beams.

An example method for facilitating position information determination includes: sending, from a user equipment (UE), an uplink reference signal to one or more base stations and a request for positioning resources to a network entity; receiving, at the UE from one or more of the one or more base stations, a plurality of first downlink reference signals in a first plurality of beams in response to the uplink reference signal and the request; determining, at the UE, a second plurality of beams, from the first plurality of beams, based on one or more respective measurements of the plurality of first downlink reference signals; and sending, from the UE to the network entity, a beam report indicating the second plurality of beams.

An example non-transitory, processor-readable storage medium includes processor-readable instructions configured to cause one or more processors of a user equipment (UE), in order to facilitate position information determination, to: send an uplink reference signal to one or more base stations and a request for positioning resources to a network entity; receive, at the UE from one or more of the one or more base stations, a plurality of first downlink reference signals in a first plurality of beams; determine a second plurality of beams, from the first plurality of beams, based on one or more respective measurements of the plurality of first downlink reference signals; and send, from the UE to the network entity, a beam report indicating the second plurality of beams.

An example server includes: a transceiver; a memory; and a processor, communicatively coupled to the transceiver and the memory, and configured to at least one of: (1) receive, via the transceiver, a plurality of indications of at least one uplink reference signal transmitted by a user equipment (UE) and received in a first plurality of beams by a first plurality of transmission/reception points (TRPs); select a second plurality of beams of a second plurality of TRPs based on the first plurality of beams; and request, via the transceiver, the second plurality of TRPs to send a first plurality of downlink reference signals to the UE using the second plurality of beams; or (2) receive, via the transceiver, a plurality of indications of received signal quality of a second plurality of downlink reference signals transmitted by a third plurality of TRPs and received by the UE; select a third plurality of beams of a fourth plurality of TRPs based on the plurality of indications of received signal quality; and request, via the transceiver, the fourth plurality of TRPs to send a third plurality of downlink reference signals to the UE using the third plurality of beams.

Another example server includes: a transceiver; and at least one of: (1) means for receiving, via the transceiver, a plurality of indications of at least one uplink reference signal transmitted by a user equipment (UE) and received in a first plurality of beams by a first plurality of transmission/reception points (TRPs); means for selecting a second plurality of beams of a second plurality of TRPs based on the first plurality of beams; and means for requesting, via the transceiver, the second plurality of TRPs to send a first plurality of downlink reference signals to the UE using the second plurality of beams; or (2) means for receiving, via the transceiver, a plurality of indications of received signal quality of a second plurality of downlink reference signals transmitted by a third plurality of TRPs and received by the UE; means for selecting a third plurality of beams of a fourth plurality of TRPs based on the plurality of indications of received signal quality; and means for requesting, via the transceiver, the fourth plurality of TRPs to send a third plurality of downlink reference signals to the UE using the third plurality of beams.

An example method for facilitating positioning of a user equipment (UE) includes at least one of: (1) receiving, at a server, a plurality of indications of at least one uplink reference signal transmitted by the UE and received in a first plurality of beams by a first plurality of transmission/reception points (TRPs); selecting a second plurality of beams of a second plurality of TRPs based on the first plurality of beams; and requesting, by the server, the second plurality of TRPs to send a first plurality of downlink reference signals to the UE using the second plurality of beams; or (2) receiving, at the server, a plurality of indications of received signal quality of a second plurality of downlink reference signals transmitted by a third plurality of TRPs and received by the UE; selecting a third plurality of beams of a fourth plurality of TRPs based on the plurality of indications of received signal quality; and requesting, by the server, the fourth plurality of TRPs to send a third plurality of downlink reference signals to the UE using the third plurality of beams.

Another example non-transitory, processor-readable storage medium includes processor-readable instructions configured to cause one or more processors of a server, in order to facilitate positioning of a user equipment, to at least one of: (1) receive a plurality of indications of at least one uplink reference signal transmitted by a user equipment (UE) and received in a first plurality of beams by a first plurality of transmission/reception points (TRPs); select a second plurality of beams of a second plurality of TRPs based on the first plurality of beams; and request the second plurality of TRPs to send a first plurality of downlink reference signals to the UE using the second plurality of beams; or (2) receive a plurality of indications of received signal quality of a second plurality of downlink reference signals transmitted by a third plurality of TRPs and received by the UE; select a third plurality of beams of a fourth plurality of TRPs based on the plurality of indications of received signal quality; and request the fourth plurality of TRPs to send a third plurality of downlink reference signals to the UE using the third plurality of beams.

An example base station includes: a transceiver; a memory; and one or more processors communicatively coupled to the transceiver and the memory and configured to: receive, via a plurality of beams of the transceiver, an uplink reference signal from a user equipment; transmit, via the transceiver to a server, a beam identity message comprising a plurality of indications each indicative of a measurement of the uplink reference signal measured using a respective one of the plurality of beams of the transceiver, and an identity of the respective one of the plurality of beams of the transceiver; receive, via the transceiver from the server in response to the beam identity message, a reference signal configuration message identifying one or more of the plurality of beams of the transceiver; and transmit, via the transceiver to the user equipment in response to the reference signal configuration message, a downlink reference signal using the one or more of the plurality of beams of the transceiver identified in the reference signal configuration message.

An example reference signal providing method includes: receiving, via a plurality of beams of a transceiver of a base station, an uplink reference signal from a user equipment; transmitting, from the base station to a server, a beam identity message comprising a plurality of indications each indicative of a measurement of the uplink reference signal measured using a respective one of the plurality of beams of the transceiver, and an identity of the respective one of the plurality of beams of the transceiver; receiving, at the base station from the server in response to the beam identity message, a reference signal configuration message identifying one or more of the plurality of beams of the transceiver; and transmitting, from the base station to the user equipment in response to the reference signal configuration message, a downlink reference signal using the one or more of the plurality of beams of the transceiver identified in the reference signal configuration message.

Another example base station includes: means for receiving an uplink reference signal from a user equipment via a plurality of beams; means for transmitting, to a server, a beam identity message comprising a plurality of indications each indicative of a measurement of the uplink reference signal measured using a respective one of the plurality of beams, and an identity of the respective one of the plurality of beams; means for receiving, station from the server in response to the beam identity message, a reference signal configuration message identifying one or more of the plurality of beams; and means for transmitting, to the user equipment in response to the reference signal configuration message, a downlink reference signal using the one or more of the plurality of beams identified in the reference signal configuration message.

Another example non-transitory, processor-readable storage medium includes processor-readable instructions configured to cause one or more processors of a base station to: receive an uplink reference signal from a user equipment via a plurality of beams of the base station; transmit, to a server, a beam identity message comprising a plurality of indications each indicative of a measurement of the uplink reference signal measured using a respective one of the plurality of beams, and an identity of the respective one of the plurality of beams; receive, from the server in response to the beam identity message, a reference signal configuration message identifying one or more of the plurality of beams; and transmit, to the user equipment in response to the reference signal configuration message, a downlink reference signal using the one or more of the plurality of beams identified in the reference signal configuration message.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of a server.

FIG. 7 is a signaling and process flow for determining position information.

FIG. 8 is a block flow diagram of a method of facilitating position information determination.

FIG. 9 is a block flow diagram of a method of requesting reference signal transmission.

FIG. 10 is a block flow diagram of reference signal providing method.

### DETAILED DESCRIPTION

Techniques are discussed herein for determining position information for a user equipment. For example, techniques are discussed for on-demand positioning resource configuration and/or hierarchical position information determination. For example, a user equipment may send a reference signal to one or more base stations and a request for (on-demand) positioning resources. The base station(s) may transmit one or more downlink reference signals (DL-RS) to the user equipment. The DL-RS may be selected based on the reference signal from the user equipment. The user equipment may measure the DL-RS and provide feedback to the base station(s) regarding the best-received DL-RS, e.g., which beam(s) carried the best-received DL-RS. The base station(s) may refine which beam(s) is(are) used to transmit DL-RS for the user equipment. The user equipment may report measurements for the received DL-RS, and may selectively report DL-RS measurement(s), e.g., based on accuracy of the measurement(s) and available payload size for reporting the measurement(s). These are examples, and other examples (e.g., of UEs and/or criteria) may be implemented.

Items and/or techniques described herein may provide one or more of the following capabilities, as well as other capabilities not mentioned. User equipment positioning may be performed with lower power consumption by reporting fewer than all reference signal measurements. User equipment positioning may be performed with lower power consumption by reducing transmitted reference signals based on user equipment reference signal measurement feedback. Positioning latency of user equipment may be reduced by transmitting a selected subset of reference signals from base stations and/or reporting a selected set of measured reference signals from a user equipment. A desirable balance may be achieved between overhead, performance (e.g., positioning accuracy), and power efficiency. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

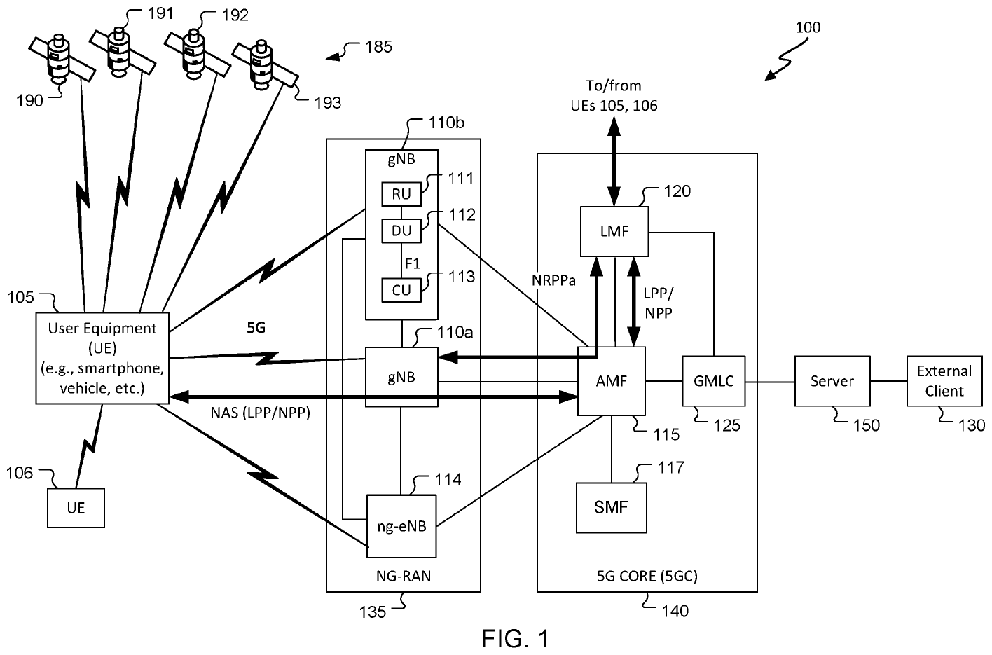

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11×protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

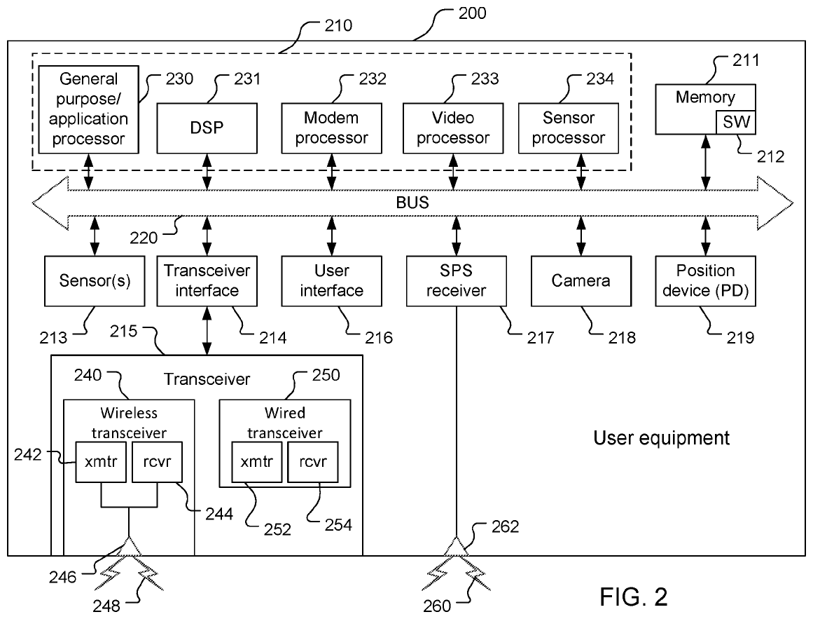

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 217, and/or another component of the UE 200, and may be provided by hardware, software, firmware, or various combinations thereof.

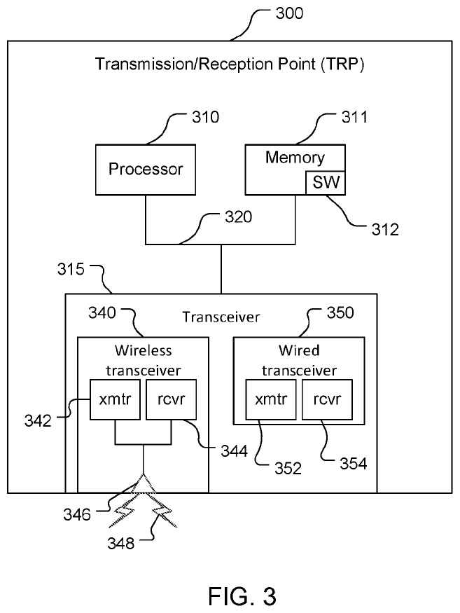

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

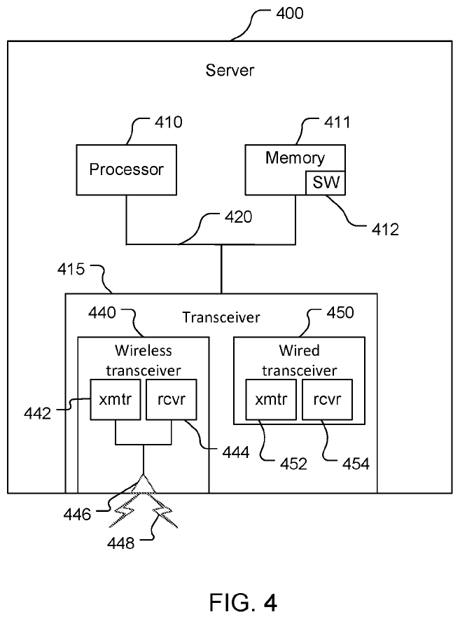

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information—Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that may be in multiple Resource Blocks (RBs) within N (one or more) consecutive symbol(s) within a slot. An RB is a collection of REs spanning a quantity of one or more consecutive symbols in the time domain and a quantity (12 for a 5G RB) of consecutive subcarriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

A UE and a server, e.g., an LMF, may engage in upper-layer message transfer, e.g., message exchange for handshaking, or message transmission to provide, e.g., UE capabilities, assistance data for measuring reference signals, and/or position information (e.g., reference signal measurement(s), range(s), position estimate(s), etc.). For example, an LMF may request capabilities of the UE, e.g., for support for E-CID, multi-RTT, DL-AoD, DL-TDOA, and/or UL positioning techniques. The UE may respond to the request by providing the capability(ies) of the UE regarding one or more of the positioning techniques. As another example, the UE may send a request for assistance data to the LMF, e.g., for use by the UE to facilitate measurement and/or other processing of one or more reference signals for one or more positioning techniques such as multi-RTT, DL-AoD, and/or DL-TDOA. The LMF may respond to the request by providing assistance data to facilitate the measurement and/or processing of one or more reference signals for one or more of the positioning techniques. As another example, the LMF may request position information from the UE, e.g., regarding E-CID, multi-RTT, DL-AoD, and/or DL-TDOA positioning techniques. The UE may respond by providing position information for one or more of the positioning techniques requested.

OTDOA-based positioning performance depends on the bandwidth (e.g., maximum bandwidth) of the UE and carrier frequency. Accuracy using OTDOA is affected by a time bandwidth product and thus the bandwidth of the UE affects the resolution providable by the UE for OTDOA. The bandwidth of the UE may vary from UE to UE, but is typically fixed for each UE and may be reported by the UE to an LMF, although each UE may have different bandwidths for different radio technologies (e.g., WiFi vs. LTE vs. NR vs. Bluetooth®, etc.). Further, different carrier frequencies may have different line of sight (LOS) paths due to different propagation of the different carrier frequencies. For example, FR2 (24.25 GHz-52.6 GHz) typically has better and/or more LOS paths, but higher loss than FR1 (410 MHz-7.125 GHz).

Angle of departure/angle of arrival (AoD/AoA) based positioning performance may depend on carrier frequency more so than bandwidth. Propagation may be more affected by carrier frequency than bandwidth, and thus AoD/AoA-based positioning performance may be more dependent on carrier frequency. AoD/AoA-based positioning may be more suitable for indoor positioning of a UE than for outdoor positioning of a UE, e.g., due to stricter outdoor requirements.

Hierarchical Beam Searching and Measurement Reporting

UEs may provide capabilities to one or more TRPs and one or more servers, e.g., LMF s, and be provided with multiple downlink reference signals for measurement. For example, DL RS such as SSB (Synchronization Signal Block), CSI-RS (Channel State Information—Reference Signal), TRS (Tracking Reference Signal), and/or PRS may be provided to and measured by a UE. The UE may measure and report more measurements than needed to determine desired position information (e.g., a position estimate with a desired level of accuracy). Further, all measurements may not be equally useful in determining position information. Consequently, techniques are discussed herein for selectively providing DL-RS, selectively measuring DL-RS, and/or selectively reporting position information based on DL-RS. This may reduce overhead and/or increase power efficiency without significantly, if at all, affecting position information determination accuracy.

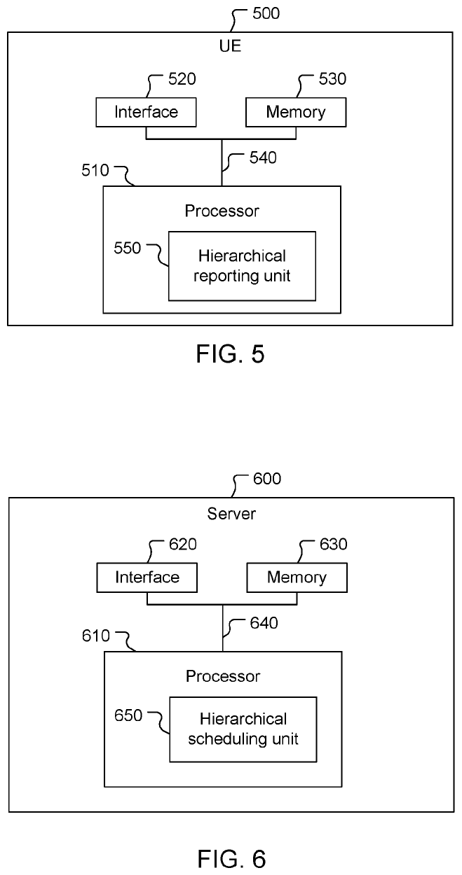

Referring to FIG. 5, with further reference to FIGS. 1-4, a UE 500 includes a processor 510, an interface 520, and a memory 530 communicatively coupled to each other by a bus 540. The UE 500 may include the components shown in FIG. 5, and may include one or more other components such as any of those shown in FIG. 2 such that the UE 200 may be an example of the UE 500. For example, the processor 510 may include one or more of the components of the processor 210. The interface 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the interface 520) includes a hierarchical reporting unit 550 configured to provide signaling to help DL-RS be selected, and to selectively report DL-RS measurements. The hierarchical reporting unit 550 is discussed further below, and the UE 500 is configured to implement the functionality discussed with respect to the hierarchical reporting unit 550. The description may refer to the processor 510 generally, or the UE 500 generally, as performing any of the functions of the hierarchical reporting unit 550.

Referring also to FIG. 6, a server 600 includes a processor 610, an interface 620, and a memory 630 communicatively coupled to each other by a bus 640. The server 600, e.g., an LMF, may include the components shown in FIG. 6, and may include one or more other components such as any of those shown in FIG. 4 such that the server 400 may be an example of the server 600. For example, the interface 620 may include one or more of the components of the transceiver 415, e.g., the wireless transmitter 442 and the antenna 446 and/or the wireless receiver 444 and the antenna 446 and/or the wired transmitter 452 and/or the wired receiver 454. The memory 630 may be configured similarly to the memory 411, e.g., including software with processor-readable instructions configured to cause the processor 610 to perform functions. The server 600 may be integrated in a physical entity with the TRP 300, with the server 600 and the TRP sharing one or more components.

The description herein may refer to the processor 610 performing a function, but this includes other implementations such as where the processor 610 executes software (stored in the memory 630) and/or firmware. The description herein may refer to the server 600 performing a function as shorthand for one or more appropriate components (e.g., the processor 610 and the memory 630) of the server 600 performing the function. The processor 610 (possibly in conjunction with the memory 630 and, as appropriate, the interface 620) includes a hierarchical scheduling unit 650. The hierarchical scheduling unit 650 is configured to request transmission of DL-RS, e.g., for a TRP 300 to transmit DL RS, based on one or more signals received from the UE 500. For example, the hierarchical scheduling unit 650 may send a request for transmission of DL-RS based on an SRS received from the UE 500 and/or based on one or more indications of DL-RS reception by the UE 500. The hierarchical scheduling unit 650 is discussed further herein, and the network entity 600 is configured to implement the functionality discussed with respect to the hierarchical reporting unit 550. The description may refer to the processor 610 generally, or the server 600 generally, as performing any of the functions of the hierarchical scheduling unit 650.

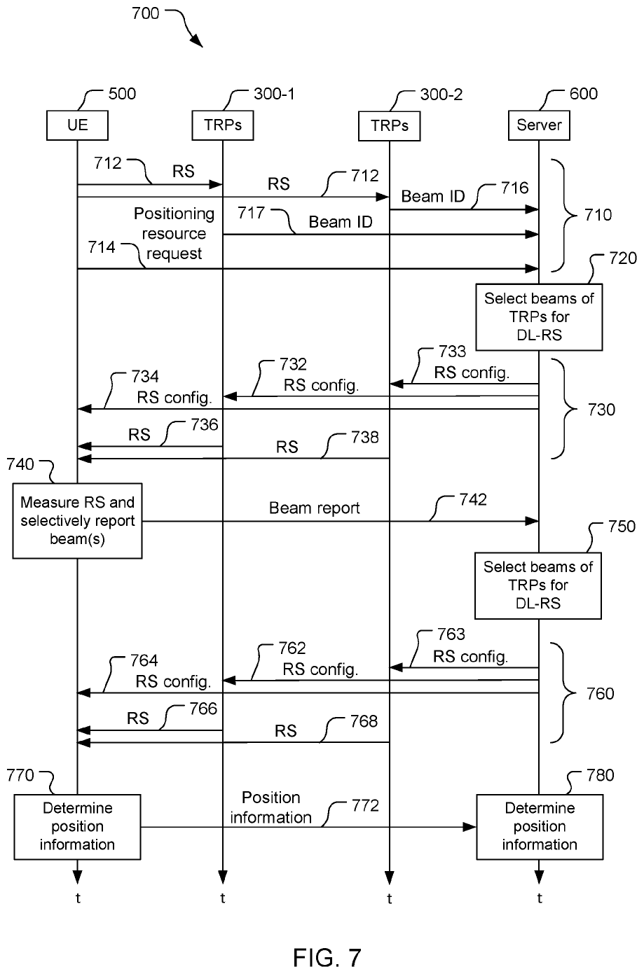

Referring also to FIG. 7, the UE 500 and the server 600, in conjunction with multiple TRPs 300-1, 300-2, are configured to cooperate to provide hierarchical positioning for the UE 500. FIG. 7 shows a signaling and process flow 700 for determining position information based on hierarchical beam selection, hierarchical signal measurement, and/or hierarchical signal measurement reporting. The flow 700 includes the stages shown and is an example only, as stages may be added, rearranged, and/or removed. While only two TRPs 300-1, 300-2 are shown in FIG. 7, the flow 700 may be applicable to more than two TRPs, and thus the two TRPs 300-1, 300-2 are shown for illustrative purposes and are not limiting of the disclosure.

At stage 710, the UE 500 sends an RS 712 and a positioning resource request 714. For example, the hierarchical reporting unit 550 may be configured to send an SRS to the TRPs 300-1, 300-2 (and any other TRP in range). The SRS may be received by the TRPs 300-1, 300-2 with respective beams. Each of the TRPs 300-1, 300-2 (e.g., a respective processor 310 of each of the TRPs 300-1, 300-2) may be configured to send to the server 600 a respective beam ID message 716, 717 indicating the beam(s) of the respective TRP 300-1, 300-2 that received the SRS. The beam ID messages 716, 717 may include RS measurement information, e.g., one or more indications of signal quality of the RS 712 received from the UE 500, and which beam corresponds to which signal measurement. The hierarchical reporting unit 550 may be configured to send the positioning resource request 714 to the server 600 (e.g., via the interface 520 and a serving TRP 300 for the UE 500) requesting resources for positioning, e.g., one or more measurement gaps, one or more DL-PRS configurations (e.g., frequency layer, offset, etc.), etc. The UE 500 may be configured to send the RS 712 and the positioning resource request 714 together, e.g., on PUCCH (Physical Uplink Control Channel), PUSCH (Physical Uplink Shared Channel), or UCI (Uplink Control Information) multiplexed on PUSCH. Also or alternatively, the UE 500 may be configured to send the RS 712 and the positioning resource request 714 separately, e.g., time division multiplexed, or back-to-back (i.e., consecutively without time separation).

As part of the positioning resource request 714, the UE 500 may report information (e.g., RAT-dependent information and/or independent information) that may help the server 600 allocate resources for positioning the UE 500 (i.e., determining position information (e.g., one or more reference signal measurements, one or more ranges, one or more position estimates, etc.) for the UE 500). The RAT-dependent information may include bandwidth of different RATs (e.g., WiFi, NR, Bluetooth®, etc.), positioning technique(s) supported for different RATs, available power for different RATs, and/or distance to one or more base stations for different RATs, etc. For example, this information may be used by the server 600 to avoid allocating cellular-based positioning resources for positioning the UE 500 if the UE 500 is unlikely to be able to support this positioning, e.g., the UE 500 is far from one or more base stations, has a narrow bandwidth, and/or has low available power. The independent information may include whether the UE 500 has an ability to determine position of the UE 500 by non-cellular means (e.g., SPS) and/or a UE type, etc. For example, the independent information may indicate that the UE 500 is a reduced-capacity UE, and/or may provide reduced-capacity characteristics of the UE 500 such as bandwidth of the UE 500, ability (or lack thereof) to support carrier aggregation and/or one or more conditions for supporting carrier aggregation, etc. Especially if the UE 500 is a reduced-capacity UE, using power efficiently to determine position of the UE 500 and/or to support another entity to determine position of the UE 500 is desirable.

The positioning resource request 714 may trigger positioning of the UE 500 including triggering allocation of resources for positioning for the UE 500. The positioning resource request 714 may request on-demand positioning resources. This on-demand positioning triggering may help efficiently use power by not using power for positioning if the position of the UE 500 is not requested, e.g., by an application running on the UE 500 or by another entity (e.g., the server 600) sending the UE 500 a position request.

At stage 720, the server 600 selects the beams of TRPs to use for sending DL-RS to the UE 500 for measurement to determine position information. The RS 712 received by the TRPs 300-1, 300-2 may help identify a candidate location of the UE 500 (which may be an RRC-connected UE (Radio Resource Control—connected UE)) and the beams used to receive the RS 712 may affect which beams to select for transmitting DL-RS to the UE 500. For example, the hierarchical scheduling unit 650 may be configured to use the beams indicated in the beam ID messages 716, 717 (and/or other beam ID messages) to select the beams and the corresponding TRPs 300, here at least the TRPs 300-1, 300-2, for sending DL-RS to the UE 500. The hierarchical scheduling unit 650 may, for example, select each beam that received the RS 712 from the UE 500, or select each beam that received the RS 712 with at least a threshold RSRP (Reference Signal Receive Power) and/or at least another threshold level indication of receive quality of the RS 712 or select each beam indicated in the beam ID messages 716, 717 (e.g., if the TRPs 300-1, 300-2 selectively reports beam IDs, e.g., the beam IDs corresponding to highest signal measurement quality, or signal measurement quality of at least a threshold quality). As another example, the hierarchical scheduling unit 650 may be configured to use the beams indicated in the beam ID messages 716, 717, velocity of the UE 500, and knowledge of available beams at the TRPs 300-1, 300-2 to select beams for transmitting DL-RS to the UE 500. The hierarchical scheduling unit 650 may be configured to consider the RAT-dependent and/or independent information provided in the positioning resource request 714 in selecting the beams and TRPs 300. Thus, the server 600 may allocate resources based on the capabilities of the UE 500 (e.g., available power, availability of positioning techniques (e.g., SPS, WiFi, etc.)). To select the beams and TRPs 300, the hierarchical scheduling unit 650 may also or alternatively consider one or more other factors such as efficiency of position information determination, positioning accuracy requirement(s), positioning accuracy providable by the UE 500, latency providable by the UE 500, and/or latency requirement(s), etc. For example, the server 600 may schedule a reduced set of beams (e.g., fewer than the beams that received the RS 712 from the UE 500), e.g., to increase efficiency if more beams would not result in significantly better positioning accuracy and/or if a required positioning accuracy does not require more beams than the reduced set. The hierarchical scheduling unit 650 may be configured to schedule the selected beams of the corresponding TRPs with appropriate RS, e.g., appropriate configuration(s) including RS type (e.g., SSB, CSI-RS, TRS, PRS, etc.), transmission parameters (e.g., frequency layer, comb number, time and frequency offsets, etc.). The selected beams may help the UE 500 to measure RS efficiently, e.g., by reducing or eliminating waste by the UE 500 attempting to measure low-quality RS. Selecting fewer beams than possible, or that might be selected if one or more factors (e.g., effect on positioning accuracy) were not considered, may reduce power consumption by one or more TRPs for beam measurement. Transmitting using fewer beams may reduce signaling traffic and thus reduce signal interference, which may help improve accuracy of signal measurement by the UE 500.

At stage 730, the server 600 requests the TRPs 300-1, 300-2 to send the DL-RS using the selected beams. The hierarchical scheduling unit 650 may send RS configuration messages 732, 733, 734 to the TRPs 300-1, 300-2 and the UE 500, respectively. The RS configuration messages 732, 733 contain at least the parameters of the RS to be sent by the TRPs 300-1, 300-2, respectively, and the respective beams to be used to send the RS. The RS configuration message 734 includes the RS parameters from both of the RS configuration messages 732, 733. The TRPs 300-1, 300-2 are configured to respond to the RS configuration messages 732, 733 by sending appropriate RS 736, 738 to the UE 500 using the indicated beams.

At stage 740, the UE 500 measures the RS 736, 738 (and any other RS from any other TRP 300 selected at stage 720 and configured at stage 730 to send RS to the UE 500). The hierarchical reporting unit 550 measures the received DL-RS and selects which corresponding beam(s) to report to the server 600. The hierarchical reporting unit 550 may, for example, select beams based on respective measurements being indicative of respective measurement quality obtainable from each of the DL-RS. For example, the hierarchical reporting unit 550 may select the received DL-RS that are best suited for positioning accuracy and/or confidence (e.g., that best meet one or more criteria (e.g., have highest values of a formula of a combination of criteria) for TDOA and/or AoD accuracy and/or confidence) and report the corresponding beams. The criteria may include measurement qualities such as RSRP, SINR, SNR, LOS/NLOS (line of sight/non-line of sight), etc. The criteria may be preconfigured (e.g., stored in the memory 530 during manufacture or dynamically configured by one or more signals received via the interface 520 and stored in the memory 530). The criteria may be selected by the hierarchical reporting unit 550. The hierarchical reporting unit 550 may employ machine learning (e.g., a neural network) and/or spatial filtering to determine the beam(s) to report. Through machine learning, the hierarchical reporting unit 550 may adapt over time to select beams that yield the best results (e.g., for positioning accuracy). The hierarchical reporting unit 550 may receive DL-RS from multiple beams across multiple cells and may report a subset (fewer than all) of the beams. The hierarchical reporting unit 550 may determine to report the best beams, or the best beams from the best subset of cells (e.g., the nearest cells, LOS cells). The hierarchical reporting unit 550 may be configured to report the beams by beam index and cell ID. The hierarchical reporting unit 550 may be configured to report the beams in order of determined desirability, e.g., with or without indicating parameter(s) associated with the beams.

The hierarchical reporting unit 550 may be configured in a variety of manners regarding what quantity of the beams to report. For example, the hierarchical reporting unit 550 may be configured to report a fixed number of beams that meet the one or more criteria, a maximum number of beams that meet the one or more criteria, and/or a minimum number of beams that meet the one or more criteria and that will enable satisfaction of one or more metrics, e.g., a desired positioning accuracy, a desired confidence, and/or a desired reliability. As another example, the hierarchical reporting unit 550 may be configured to report measurements and corresponding beams for all the DL-RS received at stage 730 and the server 600 may select the best beams for future transmission of DL-RS.

The hierarchical reporting unit 550 sends indications of the determined beams in a beam report 742 to the server 600. The beam report 742 may be sent directly from the UE 500 to the server 600 and/or via the serving TRP 300 for the UE 500 (e.g., the TRP 300-1). The beam report 742 may include position information (e.g., one or more signal measurement indications), e.g., multiplexed with the beam indication(s).

At stage 750, the server 600 determines a refined set of beams of the TRPs for DL-RS. The hierarchical scheduling unit 650 may be configured to use the beam report 742 to select a refined set of TRPs 300 for sending DL-RS to the UE 500 for measurement for use in determining a position of the UE 500. For example, the hierarchical scheduling unit 650 may select the beams included in the beam report 742 or a subset of the beams in the beam report 742, e.g., the N-best beams indicated in the beam report 742 as determined by the UE 500. The hierarchical scheduling unit 650 may be configured to consider the RAT-dependent and/or independent information provided in the positioning resource request 714 in selecting the beams and TRPs 300. Also or alternatively, the hierarchical scheduling unit 650 may use raw information from the UE 500 to determine the best beams (e.g., as discussed with respect to stage 740) and to select a subset of the measured beams for use in sending further DL-RS to the UE 500. The hierarchical scheduling unit 650 may also or alternatively select one or more beams that were not indicated in the beam report 742. For example, the hierarchical scheduling unit 650 may select a non-indicated beam adjacent to an indicated beam in the beam report 742 based on the coverage area of the indicated beam and information that the UE 500 is moving away from the coverage area of the indicated beam and toward a coverage area of the non-indicated beam. Thus, a resource ID of a beam selected at stage 750 (and transmitted at stage 760) may be the same as or different from a resource ID of a beam sent to the UE 500 during stage 730. The server 600 may allocate multiple sets of positioning resources to the UE 500.

At stage 760, the hierarchical scheduling unit 650 may request the selected beams be used to transmit DL-RS from corresponding TRPs. For example, the server 600 requests the TRPs 300-1, 300-2 to send the DL-RS using the selected beams. The hierarchical scheduling unit 650 may send RS configuration messages 762, 763, 764 to the TRPs 300-1, 300-2 and the UE 500, respectively. The RS configuration messages 762, 763 contain at least the parameters of the RS to be sent by the TRPs 300-1, 300-2, respectively, and the RS configuration message 764 includes the RS parameters from both of the RS configuration messages 762, 763. The TRPs 300-1, 300-2 are configured to respond to the RS configuration messages 762, 763 by sending appropriate RS 766, 768 to the UE 500. Selection of the beams at stage 750 and transmission of RS at stage 760 using the selected beams may help improve positioning performance, e.g., reducing power consumption by the UE 500 (and by the TRPs 300-1, 300-2), reducing latency of position information determination by reducing the quantity of measurements made by the UE 500, reducing channel traffic for RS which may help RS measurement accuracy, etc.

At stage 770, the UE 500 measures the received RS 766, 768 (and any other received RS), determines position information, and may report at least some of the position information in a position information report 772 to the server 600 (directly and/or via a serving TRP of the UE 500). For example, the UE 500 may measure TDOA and/or AoD (e.g., determine TDOA and/or AoD based on measured RS) for each measured RS and select which TDOA measurement(s) and/or which AoD measurement(s) to report based on measurement quality of the TDOA measurements and/or the AoD measurements (e.g., which may depend on signal measurement accuracies). For example, the UE 500 may report TDOAs and/or AoDs that correspond to at least a threshold TDOA measurement accuracy or at least a threshold AoD measurement accuracy, or up to respective quantities of TDOA measurements and/or AoD measurements that correspond to at least the respective threshold measurement accuracies (which may be different). The UE 500 may limit the quantity(ies) of the TDOA measurements and/or the AoD measurements that the UE 500 will report, e.g., to meet a payload size restriction for the position information report 772. The position information in the position information report 772 may include one or more measurements and/or information derived from one or more measurements (e.g., one or more ranges, one or more position estimates, etc.). The position information report 772 may include multiple messages, and/or the position information report 772 may report TDOA and AoD measurements concurrently or sequentially. The position information report 772 may include raw signal information and/or processed positioning signal information such as a reference signal measurement, a range, and/or a position estimate of the UE 500. The position information report 772 may include one or more indications of the RS and/or beams that were measured to determine the position information. The position information may be determined and included with the beam report 742. For UE-based positioning, the UE 500 may not report position information to the server 600.

At stage 780, the server 600 may determine position information for the UE 500. The server 600 may collect position information from one or more position information reports 772 and perform one or more positioning techniques to determine further position information for, e.g., ranges from raw measurements, the location of the UE 500 from ranges, etc. The server 600 may use position information from the message(s) 772 to update previously-determined position information for the UE 500.

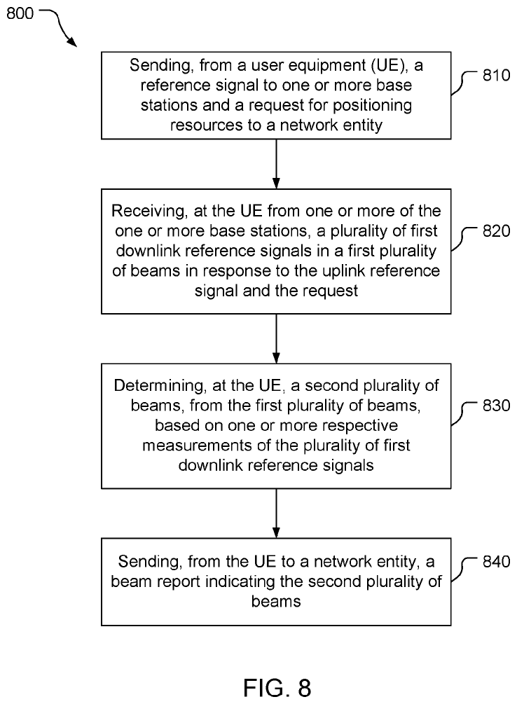

Referring to FIG. 8, with further reference to FIGS. 1-7, a method 800 of facilitating position information determination includes the stages shown. The method 800 is, however, an example only and not limiting. The method 800 may be altered, e.g., by having stages added, removed, rearranged, combined, performed concurrently, and/or having single stages split into multiple stages.

At stage 810, the method 800 includes sending, from a user equipment (UE), a reference signal to one or more base stations and a request for positioning resources to a network entity. For example, the hierarchical reporting unit 550 sends the RS 712 to the TRPs 300-1, 300-1 (and possibly other TRPs) and the positioning resource request 714 to the server 600. The processor 510, possibly in combination with the memory 530, and the interface 520 (e.g., the wireless transmitter 242 and the antenna 246 of the transceiver 215) may comprise means for sending the reference signal and the request for positioning resources.

At stage 820, the method 800 includes receiving, at the UE from one or more of the one or more base stations, a plurality of first downlink reference signals in a first plurality of beams in response to the uplink reference signal and the request. For example, the UE 500 uses RS configuration information received from the server 600 to receive the RS 736, 738 in beams selected by the server 600 based on indications of measurements of the RS 712, and based on the positioning resource request 714. The processor 510, possibly in combination with the memory 530, and the interface 520 (e.g., the wireless receiver 244 and the antenna 246 of the transceiver 215) may comprise means for receiving the plurality of first downlink reference signals.

At stage 830, the method 800 includes determining, at the UE, a second plurality of beams, from the first plurality of beams, based on one or more respective measurements of the plurality of first downlink reference signals. For example, the hierarchical reporting unit 550 determines (at stage 740) which beams yield the best measurement quality at the UE 500 based on measurements of the RS 736, 738 (and possibly RS received from one or more other TRPs). The one or more respective measurements may be the same for all the downlink reference signals, or the one or more of the respective measurements may be different for different for at least one of the downlink reference signals. The processor 510, possibly in combination with the memory 530, may comprise means for determining the second plurality of beams.

At stage 840, the method 800 includes sending, from the UE to a network entity, a beam report indicating the second plurality of beams. For example, the hierarchical reporting unit 550 sends the beam report 742 indicating the N-best beams (e.g., corresponding to signals with the N-best signal qualities). The processor 510, possibly in combination with the memory 530, and the interface 520 (e.g., the wireless transmitter 242 and the antenna 246 of the transceiver 215) may comprise means for sending the beam report.

Implementations of the method 800 may include one or more of the following features. In an example implementation, the method 800 includes receiving a plurality of second downlink reference signals transmitted in a third plurality of beams in response to the beam report; and measuring the plurality of second downlink reference signals. For example, the UE 500 receives the RS 766, 768 in beams selected by the server 600 based on the beam report 742 and measures the RS 766, 768. The beams of the RS 766, 768 may include some or all of the beams indicated in the beam report 742 and may include one or more beams not included in the beam report 742. The processor 510, possibly in combination with the memory 530, and the interface 520 (e.g., the wireless receiver 244 and the antenna 246) may comprise means for receiving the plurality of second downlink reference signals. The means for receiving the first downlink signals may be the same as the means for receiving the second downlink signals. The processor 510, possibly in combination with the memory 530, may comprise means for measuring the plurality of second downlink reference signals. In a further example implementation, the method 800 includes reporting, for each of the plurality of second downlink reference signals, a time difference of arrival and an angle of departure. For example, the hierarchical reporting unit 550 may report TDOA and/or ToA for each measured RS 766, 768 in the position information report 772. The time difference of arrival and the angle of departure may be reported sequentially or concurrently. The processor 510, possibly in combination with the memory 530, and the interface 520 (e.g., the wireless transmitter 242 and the antenna 246) may comprise means for reporting a TDOA and an AoD, and may comprise means for reporting the TDOA and the AoD concurrently, or comprise means for reporting the TDOA and the AoD sequentially, or comprise means for reporting the TDOA and the AoD either concurrently or sequentially. To report the TDOA and AoD concurrently, the UE 500 may use a larger payload size, faster processing, and/or a larger transmission bandwidth than for reporting the TDOA and AoD sequentially. In another further example implementation, the method 800 includes: measuring at least one of a time difference of arrival or an angle of departure for each of the plurality of second downlink reference signals; and determining which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure. For example, the UE 500 measures a TDOA and/or AoD for each measured RS 766, 768 and the hierarchical reporting unit 550 determines whether to report the TDOAs and/or the AoDs based on measurement accuracy of the TDOA or the AoD, respectively. The processor 510, possibly in combination with the memory 530, may comprise means for measuring at least one of the TDOA or the AoD and means for determining which of the TDOA or the AoD to report. In a further example implementation, determining which, if any, of the at least one of the time difference of arrival or the angle of departure for each of the plurality of second downlink reference signals to report to the network entity is based on a payload limit of a positioning report for reporting position information from the user equipment to the network entity. For example, the hierarchical reporting unit 550 determines which of the TDOA and/or the AoD to report based on whether sufficient payload exists in a positioning report for including the TDOA and/or the AoD.

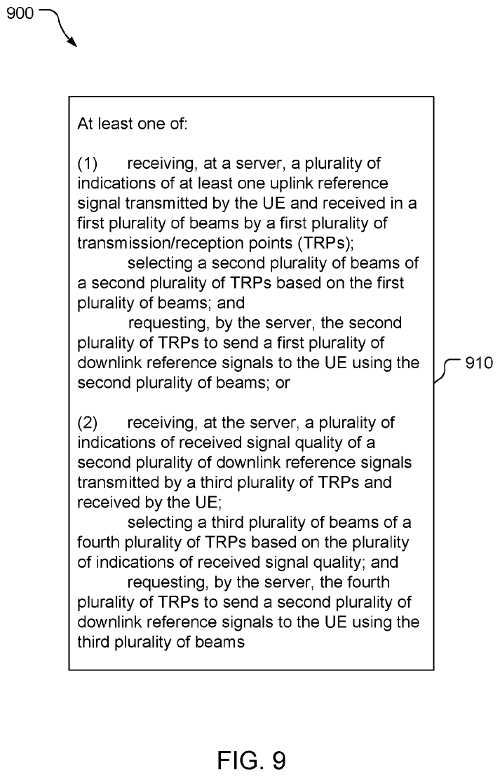

Referring to FIG. 9, with further reference to FIGS. 1-7, a method 900 of requesting reference signal transmission includes the stages shown. The method 900 is, however, an example only and not limiting. The method 900 may be altered, e.g., by having stages added, removed, rearranged, combined, performed concurrently, and/or having single stages split into multiple stages.

At stage 910, the method 900 includes at least one of (1) receiving, at a server, a plurality of indications of at least one uplink reference signal transmitted by the UE and received in a first plurality of beams by a first plurality of transmission/reception points (TRPs); selecting a second plurality of beams of a second plurality of TRPs based on the first plurality of beams; and requesting, by the server, the second plurality of TRPs to send a first plurality of downlink reference signals to the UE using the second plurality of beams; or (2) receiving, at the server, a plurality of indications of received signal quality of a second plurality of downlink reference signals transmitted by a third plurality of TRPs and received by the UE; selecting a third plurality of beams of a fourth plurality of TRPs based on the plurality of indications of received signal quality; and requesting, by the server, the fourth plurality of TRPs to send a third plurality of downlink reference signals to the UE using the third plurality of beams. For example, the server 600 receives the beam ID messages 716, 717, use the beam ID messages 716, 717 to select beams for use in sending RS to the UE 500, and request the TRPs 300-1, 300-2 (and/or one or more other TRPs) to send RS to the UE 500 using the selected beams. The hierarchical scheduling unit 650 may, for example, request the beams by sending the RS configuration messages 732, 733 to the TRPs 300-1, 300-2. Also or alternatively, the server 600 receives the beam report 742 from the UE 500 indicating received signal quality of corresponding RS, select beams to use for transmitting future RS to the UE 500, and request the TRPs 300-1, 300-2 (and/or one or more other TRPs) to send RS to the UE 500 using the selected beams. The processor 610, possibly in combination with the memory 630, and the interface 620 (e.g., the wireless receiver 444 and the antenna 446 and/or the wired receiver 454) may comprise means for receiving the indications of at least on uplink reference signal and/or means for receiving the indications of received signal quality.

Implementations of the method 900 may include one or more of the following features. In an example implementation, the method comprises (1) and further comprises receiving at least one capability indication of at least one capability of the UE, and selecting the second plurality of beams of the second plurality of TRPs comprises selecting the second plurality of beams of the second plurality of TRPs based further on the at least one capability indication. For example, the hierarchical scheduling unit 650 may use one or more capabilities of the UE 500, e.g., from RAT-dependent and/or independent information provided in the positioning resource request 714, in selecting the beams and corresponding TRPs 300 for transmitting DL-RS to the UE 500. The processor 610, possibly in combination with the memory 630, and the interface 620 (e.g., the wireless receiver 444 and the antenna 446, and/or the wired transmitter 452) may comprise means for receiving at least one capability indication. In another example implementation, the method comprises (2), and selecting the third plurality of beams of the fourth plurality of TRPs comprises selecting the third plurality of beams of the fourth plurality of TRPs to include at least one of the second plurality of beams of the second plurality of TRPs. For example, selected beams for sending DL-RS to the UE 500 may include one or more of the beams used previously for sending DL-RS to the UE 500, measurements of which were used to produce the beam report 742. Also or alternatively, the hierarchical scheduling unit 650 may use other information such as one or more capabilities of the UE 500 to select beams for sending DL-RS to the UE 500.

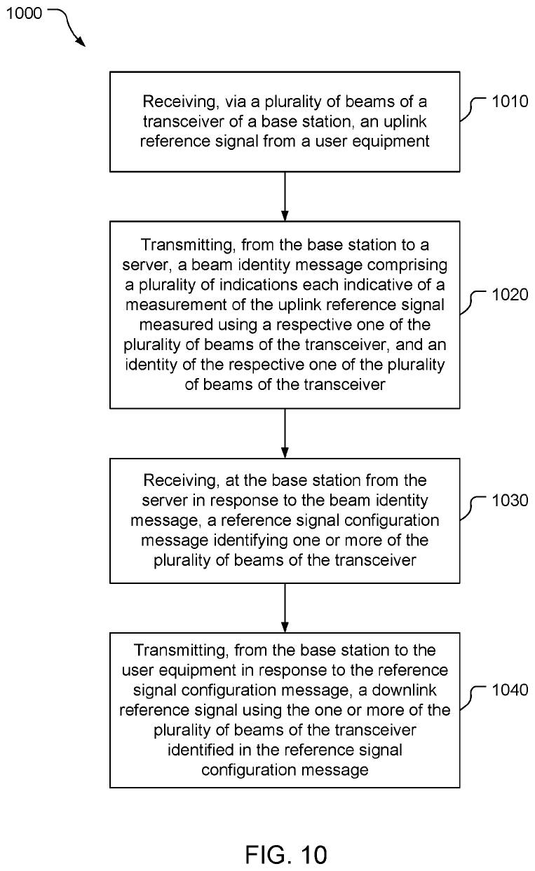

Referring to FIG. 10, with further reference to FIGS. 1-9, a reference signal providing method 1000 includes the stages shown. The method 1000 is, however, an example only and not limiting. The method 1000 may be altered, e.g., by having stages added, removed, rearranged, combined, performed concurrently, and/or having single stages split into multiple stages.

At stage 1010, the method 1000 includes receiving, via a plurality of beams of a transceiver of a base station, an uplink reference signal from a user equipment. For example, at stage 710 of the flow 700, the TRP 300-1 receives the RS 712 from the UE 500 through multiple beams of the transceiver 315 (e.g., multiple beams of the antenna 346 and the wireless receiver 344). The processor 310, possibly in combination with the memory 311, in combination with the transceiver 315 (e.g., the antenna 346 and the wireless receiver 344) may comprise means for receiving the uplink reference signal.

At stage 1020, the method 1000 includes transmitting, from the base station to a server, a beam identity message comprising a plurality of indications each indicative of a measurement of the uplink reference signal measured using a respective one of the plurality of beams of the transceiver, and an identity of the respective one of the plurality of beams of the transceiver. For example, the TRP 300-1 transmits the beam ID message 717 to the server 600 indicating beam IDs and corresponding measurements of the RS 712. The processor 310, possibly in combination with the memory 311, in combination with the transceiver 315 (e.g., the wired transmitter 352) may comprise means for transmitting the beam identity message.

At stage 1030, the method 1000 includes receiving, at the base station from the server in response to the beam identity message, a reference signal configuration message identifying one or more of the plurality of beams of the transceiver. For example, the TRP 300-1 receives the RS configuration message 732 from the server 600 indicating one or more of the beams identified in the beam ID message 717 for the TRP 300-1 to use to send a DL-RS to the UE 500. The processor 310, possibly in combination with the memory 311, in combination with the transceiver 315 (e.g., the wired receiver 354) may comprise means for receiving the reference signal configuration message.

At stage 1040, the method 1000 includes transmitting, from the base station to the user equipment in response to the reference signal configuration message, a downlink reference signal using the one or more of the plurality of beams of the transceiver identified in the reference signal configuration message. For example, the TRP 300-1 sends the RS 736 to the UE 500 using the beam(s) identified in the RS configuration message 732. The processor 310, possibly in combination with the memory 311, in combination with the transceiver 315 (e.g., the wireless transmitter 344 and the antenna 346) may comprise means for transmitting the downlink reference signal.

Implementations of the method 1000 may include one or more of the following features. In an example implementation, each of the plurality of indications of the beam identity message indicates a signal quality of the uplink reference signal.

### Implementation Examples

Implementation examples are provided in the following numbered clauses.

Clause 1. A user equipment comprising:
a transceiver;
a memory; and
one or more processors communicatively coupled to the transceiver and the memory and configured to:
   send, via the transceiver, an uplink reference signal to one or more base stations and a request for positioning resources to a network entity;
   receive, via the transceiver from one or more of the one or more base stations, a plurality of first downlink reference signals in a first plurality of beams;
   determine a second plurality of beams, from the first plurality of beams, based on one or more respective measurements of the plurality of first downlink reference signals; and
   send a beam report to the network entity indicating the second plurality of beams.

Clause 2. The user equipment of clause 1, wherein the one or more processors are configured to:
receive, via the transceiver, a plurality of second downlink reference signals transmitted in a third plurality of beams in response to the beam report; and
measure the plurality of second downlink reference signals.

Clause 3. The user equipment of clause 2, wherein the one or more processors are configured to report, for each of the plurality of second downlink reference signals, a time difference of arrival and an angle of departure, wherein the one or more processors are configured to report the time difference of arrival and the angle of departure concurrently, or are configured to report the time difference of arrival and the angle of departure sequentially, or are configured to report the time difference of arrival and the angle of departure either concurrently or sequentially.

Clause 4. The user equipment of clause 2, wherein the one or more processors are configured to:
measure at least one of a time difference of arrival or an angle of departure for each of the plurality of second downlink reference signals; and
determine which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure.

Clause 5. The user equipment of clause 4, wherein the one or more processors are configured to determine which, if any, of the at least one of the time difference of arrival or the angle of departure for each of the plurality of second downlink reference signals to report to the network entity based on a payload limit of a positioning report for reporting position information from the user equipment to the network entity.

Clause 6. A user equipment comprising:
means for sending an uplink reference signal to one or more base stations and a request for positioning resources to a network entity;
means for receiving, from one or more of the one or more base stations, a plurality of first downlink reference signals in a first plurality of beams;
means for determining a second plurality of beams, from the first plurality of beams, based on one or more respective measurements of the plurality of first downlink reference signals; and
means for sending a beam report to the network entity indicating the second plurality of beams.

Clause 7. The user equipment of clause 6, further comprising:
means for receiving a plurality of second downlink reference signals transmitted in a third plurality of beams in response to the beam report; and
means for measuring the plurality of second downlink reference signals.

Clause 8. The user equipment of clause 7, further comprising means for reporting, for each of the plurality of second downlink reference signals, a time difference of arrival and an angle of departure, wherein the means for reporting comprise means for reporting the time difference of arrival and the angle of departure concurrently, or comprise means for reporting the time difference of arrival and the angle of departure sequentially, or comprise means for reporting the time difference of arrival and the angle of departure either concurrently or sequentially.

Clause 9. The user equipment of clause 7, further comprising:
means for measuring at least one of a time difference of arrival or an angle of departure for each of the plurality of second downlink reference signals; and
means for determining which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure.

Clause 10. The user equipment of clause 9, wherein the means for determining which, if any, of the at least one of the time difference of arrival or the angle of departure for each of the plurality of second downlink reference signals to report to the network entity comprise means for determining which, if any, of the at least one of the time difference of arrival or the angle of departure for each of the plurality of second downlink reference signals to report to the network entity based on a payload limit of a positioning report for reporting position information from the user equipment to the network entity.

Clause 11. A method for facilitating position information determination, the method comprising:
sending, from a user equipment (UE), an uplink reference signal to one or more base stations and a request for positioning resources to a network entity;
receiving, at the UE from one or more of the one or more base stations, a plurality of first downlink reference signals in a first plurality of beams in response to the uplink reference signal and the request;
determining, at the UE, a second plurality of beams, from the first plurality of beams, based on one or more respective measurements of the plurality of first downlink reference signals; and
sending, from the UE to the network entity, a beam report indicating the second plurality of beams.

Clause 12. The method of clause 11, further comprising:
receiving a plurality of second downlink reference signals transmitted in a third plurality of beams in response to the beam report; and
measuring the plurality of second downlink reference signals.

Clause 13. The method of clause 12, further comprising reporting, for each of the plurality of second downlink reference signals, a time difference of arrival and an angle of departure.

Clause 14. The method of clause 12, further comprising:
measuring at least one of a time difference of arrival or an angle of departure for each of the plurality of second downlink reference signals; and
determining which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure.

Clause 15. The method of clause 14, wherein determining which, if any, of the at least one of the time difference of arrival or the angle of departure for each of the plurality of second downlink reference signals to report to the network entity is based on a payload limit of a positioning report for reporting position information from the UE to the network entity.

Clause 16. A non-transitory, processor-readable storage medium comprising processor-readable instructions configured to cause one or more processors of a user equipment (UE), in order to facilitate position information determination, to:
send an uplink reference signal to one or more base stations and a request for positioning resources to a network entity;
receive, at the UE from one or more of the one or more base stations, a plurality of first downlink reference signals in a first plurality of beams;
determine a second plurality of beams, from the first plurality of beams, based on one or more respective measurements of the plurality of first downlink reference signals; and
send, from the UE to the network entity, a beam report indicating the second plurality of beams.

Clause 17. The non-transitory, processor-readable storage medium of clause 16, further comprising processor-readable instructions configured to cause the one or more processors to:
receive a plurality of second downlink reference signals transmitted in a third plurality of beams in response to the beam report; and
measure the plurality of second downlink reference signals.

Clause 18. The non-transitory, processor-readable storage medium of clause 17, further comprising processor-readable instructions configured to cause the one or more processors to report, for each of the plurality of second downlink reference signals, a time difference of arrival and an angle of departure, wherein the processor-readable instructions configured to cause the one or more processors to report the time difference of arrival and the angle of departure comprise processor-readable instructions configured to cause the one or more processors to report the time difference of arrival and the angle of departure concurrently, or comprise processor-readable instructions configured to cause the one or more processors to report the time difference of arrival and the angle of departure sequentially, or comprise processor-readable instructions configured to cause the one or more processors to report the time difference of arrival and the angle of departure either concurrently or sequentially.

Clause 19. The non-transitory, processor-readable storage medium of clause 17, further comprising processor-readable instructions configured to cause the one or more processors to:
measure at least one of a time difference of arrival or an angle of departure for each of the plurality of second downlink reference signals; and
determine which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure.

Clause 20. The non-transitory, processor-readable storage medium of clause 19, wherein the processor-readable instructions configured to cause the one or more processors to determine which, if any, of the at least one of the time difference of arrival or the angle of departure for each of the plurality of second downlink reference signals to report to the network entity comprise processor-readable instructions configured to cause the one or more processors to determine which, if any, of the at least one of the time difference of arrival or the angle of departure for each of the plurality of second downlink reference signals to report to the network entity based on a payload limit of a positioning report for reporting position information from the UE to the network entity.

Clause 21. A server comprising:
a transceiver;
a memory; and
a processor, communicatively coupled to the transceiver and the memory, and configured to at least one of:
   (1) receive, via the transceiver, a plurality of indications of at least one uplink reference signal transmitted by a user equipment (UE) and received in a first plurality of beams by a first plurality of transmission/reception points (TRPs);
      select a second plurality of beams of a second plurality of TRPs based on the first plurality of beams; and
      request, via the transceiver, the second plurality of TRPs to send a first plurality of downlink reference signals to the UE using the second plurality of beams; or
   (2) receive, via the transceiver, a plurality of indications of received signal quality of a second plurality of downlink reference signals transmitted by a third plurality of TRPs and received by the UE;
   select a third plurality of beams of a fourth plurality of TRPs based on the plurality of indications of received signal quality; and
   request, via the transceiver, the fourth plurality of TRPs to send a third plurality of downlink reference signals to the UE using the third plurality of beams.

Clause 22. The server of clause 21, wherein the processor is configured according to (1), and wherein the processor is configured to:
receive at least one capability indication of at least one capability of the UE; and
select the second plurality of beams of the second plurality of TRPs based further on the at least one capability indication.

Clause 23. The server of clause 21, wherein the processor is configured according to (2), and wherein the processor is configured to select the third plurality of beams of the fourth plurality of TRPs to include at least one of the second plurality of beams of the second plurality of TRPs.

Clause 24. A server comprising:
a transceiver; and
at least one of:
   (1) means for receiving, via the transceiver, a plurality of indications of at least one uplink reference signal transmitted by a user equipment (UE) and received in a first plurality of beams by a first plurality of transmission/reception points (TRPs);
      means for selecting a second plurality of beams of a second plurality of TRPs based on the first plurality of beams; and
      means for requesting, via the transceiver, the second plurality of TRPs to send a first plurality of downlink reference signals to the UE using the second plurality of beams; or
   (2) means for receiving, via the transceiver, a plurality of indications of received signal quality of a second plurality of downlink reference signals transmitted by a third plurality of TRPs and received by the UE;
      means for selecting a third plurality of beams of a fourth plurality of TRPs based on the plurality of indications of received signal quality; and
      means for requesting, via the transceiver, the fourth plurality of TRPs to send a third plurality of downlink reference signals to the UE using the third plurality of beams.

Clause 25. The server of clause 24, wherein the server comprises (1) and further comprises means for receiving at least one capability indication of at least one capability of the UE, and wherein the means for selecting the second plurality of beams of the second plurality of TRPs are for selecting the second plurality of beams of the second plurality of TRPs based further on the at least one capability indication.

Clause 26. The server of clause 24, wherein the server comprises (2), and wherein the means for selecting the third plurality of beams of the fourth plurality of TRPs are for selecting the third plurality of beams of the fourth plurality of TRPs to include at least one of the second plurality of beams of the second plurality of TRPs.

Clause 27. A method for facilitating positioning of a user equipment (UE), the method comprising at least one of:
(1) receiving, at a server, a plurality of indications of at least one uplink reference signal transmitted by the UE and received in a first plurality of beams by a first plurality of transmission/reception points (TRPs);
   selecting a second plurality of beams of a second plurality of TRPs based on the first plurality of beams; and
   requesting, by the server, the second plurality of TRPs to send a first plurality of downlink reference signals to the UE using the second plurality of beams; or
(2) receiving, at the server, a plurality of indications of received signal quality of a second plurality of downlink reference signals transmitted by a third plurality of TRPs and received by the UE;
   selecting a third plurality of beams of a fourth plurality of TRPs based on the plurality of indications of received signal quality; and
   requesting, by the server, the fourth plurality of TRPs to send a third plurality of downlink reference signals to the UE using the third plurality of beams.

Clause 28. The method of clause 27, wherein the method comprises (1) and further comprises receiving at least one capability indication of at least one capability of the UE, and wherein selecting the second plurality of beams of the second plurality of TRPs comprises selecting the second plurality of beams of the second plurality of TRPs based further on the at least one capability indication.

Clause 29. The method of clause 27, wherein the method comprises (2), and wherein selecting the third plurality of beams of the fourth plurality of TRPs comprises selecting the third plurality of beams of the fourth plurality of TRPs to include at least one of the second plurality of beams of the second plurality of TRPs.

Clause 30. A non-transitory, processor-readable storage medium comprising processor-readable instructions configured to cause one or more processors of a server, in order to facilitate positioning of a user equipment, to at least one of:
(1) receive a plurality of indications of at least one uplink reference signal transmitted by a user equipment (UE) and received in a first plurality of beams by a first plurality of transmission/reception points (TRPs);
   select a second plurality of beams of a second plurality of TRPs based on the first plurality of beams; and
   request the second plurality of TRPs to send a first plurality of downlink reference signals to the UE using the second plurality of beams; or
(2) receive a plurality of indications of received signal quality of a second plurality of downlink reference signals transmitted by a third plurality of TRPs and received by the UE;
   select a third plurality of beams of a fourth plurality of TRPs based on the plurality of indications of received signal quality; and
   request the fourth plurality of TRPs to send a third plurality of downlink reference signals to the UE using the third plurality of beams.

Clause 31. The storage medium of clause 30, wherein the storage medium comprises the processor-readable instructions configured to cause the one or more processors to receive, select, and request according to (1), wherein the storage medium further comprises processor-readable instructions configured to cause the one or more processors to receive at least one capability indication of at least one capability of the UE, and wherein the processor-readable instructions configured to cause the one or more processors to select the second plurality of beams of the second plurality of TRPs comprise processor-readable instructions configured to cause the one or more processors to select the second plurality of beams of the second plurality of TRPs based further on the at least one capability indication.

Clause 32. The storage medium of clause 30, wherein the storage medium comprises the processor-readable instructions configured to cause the one or more processors to receive, select, and request according to (2), and wherein the processor-readable instructions configured to cause the one or more processors to select the third plurality of beams of the fourth plurality of TRPs comprise processor-readable instructions configured to cause the one or more processors to select the third plurality of beams of the fourth plurality of TRPs to include at least one of the second plurality of beams of the second plurality of TRPs.

Clause 33. A base station comprising:
a transceiver;
a memory; and
one or more processors communicatively coupled to the transceiver and the memory and configured to:
   receive, via a plurality of beams of the transceiver, an uplink reference signal from a user equipment;
   transmit, via the transceiver to a server, a beam identity message comprising a plurality of indications each indicative of a measurement of the uplink reference signal measured using a respective one of the plurality of beams of the transceiver, and an identity of the respective one of the plurality of beams of the transceiver;
   receive, via the transceiver from the server in response to the beam identity message, a reference signal configuration message identifying one or more of the plurality of beams of the transceiver; and
   transmit, via the transceiver to the user equipment in response to the reference signal configuration message, a downlink reference signal using the one or more of the plurality of beams of the transceiver identified in the reference signal configuration message.
   Clause 34. The base station of clause 33, wherein each of the plurality of indications of the beam identity message indicates a signal quality of the uplink reference signal.

Clause 35. A reference signal providing method comprising:
receiving, via a plurality of beams of a transceiver of a base station, an uplink reference signal from a user equipment;
transmitting, from the base station to a server, a beam identity message comprising a plurality of indications each indicative of a measurement of the uplink reference signal measured using a respective one of the plurality of beams of the transceiver, and an identity of the respective one of the plurality of beams of the transceiver;
receiving, at the base station from the server in response to the beam identity message, a reference signal configuration message identifying one or more of the plurality of beams of the transceiver; and
transmitting, from the base station to the user equipment in response to the reference signal configuration message, a downlink reference signal using the one or more of the plurality of beams of the transceiver identified in the reference signal configuration message.

Clause 36. The reference signal providing method of clause 35, wherein each of the plurality of indications of the beam identity message indicates a signal quality of the uplink reference signal.

Clause 37. A base station comprising:
means for receiving an uplink reference signal from a user equipment via a plurality of beams;
means for transmitting, to a server, a beam identity message comprising a plurality of indications each indicative of a measurement of the uplink reference signal measured using a respective one of the plurality of beams, and an identity of the respective one of the plurality of beams;
means for receiving, station from the server in response to the beam identity message, a reference signal configuration message identifying one or more of the plurality of beams; and
means for transmitting, to the user equipment in response to the reference signal configuration message, a downlink reference signal using the one or more of the plurality of beams identified in the reference signal configuration message.

Clause 38. The base station of clause 37, wherein each of the plurality of indications of the beam identity message indicates a signal quality of the uplink reference signal.

Clause 39. A non-transitory, processor-readable storage medium comprising processor-readable instructions configured to cause one or more processors of a base station to:
receive an uplink reference signal from a user equipment via a plurality of beams of the base station;
transmit, to a server, a beam identity message comprising a plurality of indications each indicative of a measurement of the uplink reference signal measured using a respective one of the plurality of beams, and an identity of the respective one of the plurality of beams;
receive, from the server in response to the beam identity message, a reference signal configuration message identifying one or more of the plurality of beams; and
transmit, to the user equipment in response to the reference signal configuration message, a downlink reference signal using the one or more of the plurality of beams identified in the reference signal configuration message.

Clause 40. The non-transitory, processor-readable storage medium of clause 39, wherein each of the plurality of indications of the beam identity message indicates a signal quality of the uplink reference signal.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment comprising:
a transceiver;
a memory; and
one or more processors communicatively coupled to the transceiver and the memory and configured to:
send, via the transceiver, an uplink reference signal to one or more base stations and a request for positioning resources to a network entity;
receive, via the transceiver from one or more of the one or more base stations, a plurality of first downlink reference signals in a first plurality of beams;
determine a second plurality of beams, from the first plurality of beams, based on one or more respective measurements of the plurality of first downlink reference signals; and
send a beam report to the network entity indicating the second plurality of beams.

2. The user equipment of claim 1, wherein the one or more processors are configured to:
receive, via the transceiver, a plurality of second downlink reference signals transmitted in a third plurality of beams in response to the beam report; and
measure the plurality of second downlink reference signals.

3. The user equipment of claim 2, wherein the one or more processors are configured to report, for each of the plurality of second downlink reference signals, a time difference of arrival and an angle of departure, wherein the one or more processors are configured to report the time difference of arrival and the angle of departure concurrently, or are configured to report the time difference of arrival and the angle of departure sequentially, or are configured to report the time difference of arrival and the angle of departure either concurrently or sequentially.

4. The user equipment of claim 2, wherein the one or more processors are configured to:
measure at least one of a time difference of arrival or an angle of departure for each of the plurality of second downlink reference signals; and
determine which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure.

5. The user equipment of claim 4, wherein the one or more processors are configured to determine which, if any, of the at least one of the time difference of arrival or the angle of departure for each of the plurality of second downlink reference signals to report to the network entity based on a payload limit of a positioning report for reporting position information from the user equipment to the network entity.

6. A method for facilitating position information determination, the method comprising:
sending, from a user equipment (UE), an uplink reference signal to one or more base stations and a request for positioning resources to a network entity;
receiving, at the UE from one or more of the one or more base stations, a plurality of first downlink reference signals in a first plurality of beams in response to the uplink reference signal and the request;
determining, at the UE, a second plurality of beams, from the first plurality of beams, based on one or more respective measurements of the plurality of first downlink reference signals; and
sending, from the UE to the network entity, a beam report indicating the second plurality of beams.

7. The method of claim 6, further comprising:
receiving a plurality of second downlink reference signals transmitted in a third plurality of beams in response to the beam report; and
measuring the plurality of second downlink reference signals.

8. The method of claim 7, further comprising reporting, for each of the plurality of second downlink reference signals, a time difference of arrival and an angle of departure.

9. The method of claim 7, further comprising:
measuring at least one of a time difference of arrival or an angle of departure for each of the plurality of second downlink reference signals; and
determining which, if any, of the at least one of the time difference of arrival or the angle of departure for each of the plurality of second downlink reference signals to report to the network entity based on a respective first measurement accuracy of the respective time difference of arrival or a respective second measurement accuracy of the respective angle of departure.

10. The method of claim 9, wherein determining which, if any, of the at least one of the time difference of arrival or the angle of departure for each of the plurality of second downlink reference signals to report to the network entity is based on a payload limit of a positioning report for reporting position information from the UE to the network entity.

11. A server comprising:
a transceiver;
a memory; and
a processor, communicatively coupled to the transceiver and the memory, and configured to at least one of:
(1) receive, via the transceiver, a plurality of indications of at least one uplink reference signal transmitted by a user equipment (UE) and received in a first plurality of beams by a first plurality of transmission/reception points (TRPs);
select a second plurality of beams of a second plurality of TRPs based on the first plurality of beams; and
request, via the transceiver, the second plurality of TRPs to send a first plurality of downlink reference signals to the UE using the second plurality of beams; or
(2) receive, via the transceiver, a plurality of indications of received signal quality of a second plurality of downlink reference signals transmitted by a third plurality of TRPs and received by the UE;
select a third plurality of beams of a fourth plurality of TRPs based on the plurality of indications of received signal quality; and
request, via the transceiver, the fourth plurality of TRPs to send a third plurality of downlink reference signals to the UE using the third plurality of beams.

12. The server of claim 11, wherein the processor is configured according to (1), and wherein the processor is configured to:
receive at least one capability indication of at least one capability of the UE; and
select the second plurality of beams of the second plurality of TRPs based further on the at least one capability indication.

13. The server of claim 11, wherein the processor is configured according to (2), and wherein the processor is configured to select the third plurality of beams of the fourth plurality of TRPs to include at least one of the second plurality of beams of the second plurality of TRPs.

14. A method for facilitating positioning of a user equipment (UE), the method comprising at least one of:
(1) receiving, at a server, a plurality of indications of at least one uplink reference signal transmitted by the UE and received in a first plurality of beams by a first plurality of transmission/reception points (TRPs);
selecting a second plurality of beams of a second plurality of TRPs based on the first plurality of beams; and
requesting, by the server, the second plurality of TRPs to send a first plurality of downlink reference signals to the UE using the second plurality of beams; or
(2) receiving, at the server, a plurality of indications of received signal quality of a second plurality of downlink reference signals transmitted by a third plurality of TRPs and received by the UE;
selecting a third plurality of beams of a fourth plurality of TRPs based on the plurality of indications of received signal quality; and
requesting, by the server, the fourth plurality of TRPs to send a third plurality of downlink reference signals to the UE using the third plurality of beams.

15. The method of claim 14, wherein the method comprises (1) and further comprises receiving at least one capability indication of at least one capability of the UE, and wherein selecting the second plurality of beams of the second plurality of TRPs comprises selecting the second plurality of beams of the second plurality of TRPs based further on the at least one capability indication.

16. The method of claim 14, wherein the method comprises (2), and wherein selecting the third plurality of beams of the fourth plurality of TRPs comprises selecting the third plurality of beams of the fourth plurality of TRPs to include at least one of the second plurality of beams of the second plurality of TRPs.

17. A base station comprising:
a transceiver;
a memory; and
one or more processors communicatively coupled to the transceiver and the memory and configured to:
receive, via a plurality of beams of the transceiver, an uplink reference signal from a user equipment;
transmit, via the transceiver to a server, a beam identity message comprising a plurality of indications each indicative of a measurement of the uplink reference signal measured using a respective one of the plurality of beams of the transceiver, and an identity of the respective one of the plurality of beams of the transceiver;
receive, via the transceiver from the server in response to the beam identity message, a reference signal configuration message identifying one or more of the plurality of beams of the transceiver; and
transmit, via the transceiver to the user equipment in response to the reference signal configuration message, a downlink reference signal using the one or more of the plurality of beams of the transceiver identified in the reference signal configuration message.

18. The base station of claim 17, wherein each of the plurality of indications of the beam identity message indicates a signal quality of the uplink reference signal.

19. A reference signal providing method comprising:
receiving, via a plurality of beams of a transceiver of a base station, an uplink reference signal from a user equipment;
transmitting, from the base station to a server, a beam identity message comprising a plurality of indications each indicative of a measurement of the uplink reference signal measured using a respective one of the plurality of beams of the transceiver, and an identity of the respective one of the plurality of beams of the transceiver;
receiving, at the base station from the server in response to the beam identity message, a reference signal configuration message identifying one or more of the plurality of beams of the transceiver; and
transmitting, from the base station to the user equipment in response to the reference signal configuration message, a downlink reference signal using the one or more of the plurality of beams of the transceiver identified in the reference signal configuration message.

20. The reference signal providing method of claim 19, wherein each of the plurality of indications of the beam identity message indicates a signal quality of the uplink reference signal.
